(19) United States
(12) Patent Application Publication
(10) Pub. No.: US 2018/0086584 A1
(43) Pub. Date: Mar. 29, 2018

(54) WEB TRANSPORT ASSEMBLY FOR TRANSPORTING A WEB ALONG A PROCESSING UNIT

(71) Applicant: Océ Holding B.V., Venlo (NL)

(72) Inventors: Romeo MUSETE, New Westminster (CA); Michael NELL, Vancouver (CA)

(73) Assignee: Océ Holding B.V., Venlo (NL)

(21) Appl. No.: 15/710,508

(22) Filed: Sep. 20, 2017

(30) Foreign Application Priority Data
Sep. 28, 2016 (EP) 16190970.0

(51) Int. Cl. B65H 23/24

(52) U.S. Cl. CPC B65H 23/245; B41J 15/04

(57) ABSTRACT

A web transport assembly is provided for transporting a web along a processing unit for processing the web, the web transport assembly comprising:
a transport device arranged for moving the web in a transport direction through a transport path along the processing unit, the transport device being arranged downstream of the processing unit relative to the transport direction; and
a friction-based tensioning device arranged upstream of the processing unit relative to the transport direction; wherein the friction-based tensioning device comprises a guiding surface for guiding the web towards the processing unit and a plurality of suction holes distributed over the guiding surface for providing a suction force to a contact side of the web, the plurality of suction holes being arranged in fluid communication to a suction source, which generates the suction force, wherein the guiding surface is configured to exert a friction force on the web in response to the suction force provided to the contact side of the web; and wherein the friction-based tensioning device is configured for controlling a tension of the web between the guiding surface and the transport device.

### FIELD OF THE INVENTION

The present invention pertains to a web transport assembly for transporting a web along a processing unit. The present invention further pertains to a printer apparatus comprising the web transport assembly according to present invention.

### BACKGROUND ART

In a known web transport assembly a web is transported along a processing unit. The processing unit is configured for processing the web, such as by forming an image on the web.

The known web transport assembly comprises a transport device, such as a transport nip, which is arranged for moving the web in a transport direction through a transport path along the processing unit. The transport device is arranged downstream of the processing unit relative to the transport direction.

The web transport assembly further comprises a dancer assembly for controlling a tension of the web in a direction along the transport path. The dancer assembly is arranged upstream of the processing unit in between a roll for supplying the web and the processing unit. The dancer assembly comprises a roller having a guiding surface arranged in contact with the web and two suspension linkages. Each suspension linkage connects the roller at one of its ends to a frame. The web is upwards curved along the guiding surface of the roller. The dancer assembly controls the tension of the web by the weight of the roller and/or any spring force, which is provided by a spring mechanism to act on the web via the guiding surface.

The web transport assembly further comprises a turn element arranged between the dancer assembly and the processing unit, which turn element has a guiding surface arranged for turning the web towards the processing unit. The turn element is arranged stationary with respect to the transport path.

A disadvantage of the known web transport assembly is that a control on the tension of the web at the processing unit may be disturbed by a friction of the web when sliding the web over the turn element.

Furthermore, the dancer assembly adds complexity to the web transport assembly, thereby increasing the cost of the web transport assembly.

It is an object of the present invention to provide a web transport assembly for transporting a web along a processing unit, wherein the web transport assembly provides improved control on the tension of the web during transport along the processing unit while reducing complexity of the web transport assembly.

### SUMMARY OF THE INVENTION

In an aspect of the present invention, a web transport assembly is provided for transporting a web along a processing unit for processing the web, the web transport assembly comprising:
a transport device arranged for moving the web in a transport direction through a transport path along the processing unit, the transport device being arranged downstream of the processing unit relative to the transport direction; and
a friction-based tensioning device arranged upstream of the processing unit relative to the transport direction; wherein the friction-based tensioning device comprises a guiding surface for guiding the web towards the processing unit and a plurality of suction holes distributed over the guiding surface for providing a suction force to a contact side of the web, the plurality of suction holes being arranged in fluid communication to a suction source, which generates the suction force, wherein the guiding surface is configured to exert a friction force on the web in response to the suction force provided to the contact side of the web; and wherein the friction-based tensioning device is configured for controlling a tension of the web between the guiding surface and the transport device.

The friction-based tensioning device provides a suction force via the suction holes to the contact side of the web. As a result the web is controllably held in contact with the guiding surface of the friction-based tensioning device. The guiding surface is configured to exert a friction force on the contact side of the web in response to the suction force provided to the contact side of the web. The friction-based tensioning device is configured for controlling a tension of the web between the guiding surface and the transport device based on the friction force provided.

In an example, the transport device transports the web in the transport direction through the transport path along the processing unit, while the web slides along the guiding surface in response to the friction force provided. As such, the friction force at the guiding surface determines the tension of the web between the guiding surface and the transport device.

In another example, the friction-based tensioning device comprises a rotatable roller comprising the guiding surface at its circumference; and the friction-based tensioning device further comprises a friction mechanism, such as a journal bearing assembly or a plain bearing assembly, coupled to the rotatable roller and configured for controlling a friction force for restraining a rotation of the roller around its rotation axis. The friction force provided by the friction mechanism to the rotatable roller controllably restrains the rotation of the roller around its rotation axis. The guiding surface of the roller is in rolling contact to the contact side of the web while controlling the tension of the web by the friction mechanism restricting a rotation of the roller. As a result, said friction force generated by the friction mechanism determines the tension of the web along the transport path between the guiding surface and the transport device. In this example, the friction force acting on the contact side of the web via the guiding surface is selected higher than the friction force acting on the roller, which restrains the rotation of the roller, in order to prevent a sliding movement of the web over the guiding surface.

The friction-based tensioning device may comprise an array of suction holes arranged across the transport path. In this way, the suction force is easily provided to the web at the guiding surface along a transverse direction arranged across to the transport path.

The web transport assembly further comprises a control unit operatively coupled to the suction source to control the friction force provided to the contact side of the web. The control unit controls the suction force, such as a negative air pressure, provided by the suction source to the contact side of the web via the plurality of suction holes. The control unit is configured to adjust the friction force provided by the guiding surface to the web by adjusting the suction force. The control unit may be operatively coupled to a suction pump as suction source to control the suction force. Alternatively or additionally, the suction source may comprise a valve for controlling the suction force communicated to the suction holes and the control unit is operatively coupled to the valve to control the suction force.

In an example, the control unit may be configured to adjust the suction force in response to a media type selected for the web and based on a media catalogue comprising a set of media types, each media type being associated to a suction force level, such as a negative air pressure level, for controlling the friction force. In this way, the friction force is easily controlled independent of the media type used as a web. A media type of the web may affect the friction force generated by the guiding surface in response to the suction force, such as by a surface property of the contact side of the web and/or a suction permeability of the web.

In another example, the control unit may be configured to adjust the friction force based on a movement of the web by the transport device along the transport device. In particular, a sensor may be provided along the transport path to determine a movement of the web by the transport device along the transport path. The sensor is connected to the control unit to provide a signal to the control unit indicating the movement of the web along the transport path. The control unit may adjust the friction force provided to the contact side of the web to control the tension of the web such that a measured movement of the web provided by the transport device is substantially equal to a desired movement of the web.

The web transport assembly further comprises a support plate for supporting the web at the processing unit, the support plate being configured for attracting the web to the support plate. The processing unit may comprise a processing head, such as a print head, arranged for facing the support plate. The support plate supports processing of the web by the processing unit by attracting the web to the support plate, thereby arranging the web at a predetermined processing position.

In an example, the support plate may comprise a plurality of suction holes distributed over the support plate for communicating a suction force to the web to attract the web to the support plate. In an alternative example, the support plate may be configured to attract the web to the support plate by an electrostatic force.

The control unit is configured to control the suction force at the guiding surface, such that a friction force provided to the web by the guiding surface exceeds or is substantially higher than a friction force provided to the web by the support plate. In this way, the friction-based tensioning device accurately controls the tension of the web along the transport path between the guiding surface and the transport device. As the friction force of the guiding surface is controlled to be higher than a friction force provided to the web by the support plate, the tension of the web along the transport path is accurately controlled. As such, a movement of the web along the transport path is accurately controlled by the transport device independently of the attraction of the web to the support plate as the tension of the web along the transport path is accurately controlled by the friction-based tensioning device.

In an embodiment, the control unit is configured to control the attraction of the web to the support plate; and wherein the control unit is configured to adjust the attraction of the web to the support plate depending on a movement of the web by the transport device along the support plate. In an example, the control unit may reduce an attraction force to the support plate, when the web is moved along the support plate, and/or may increase the attraction force to the support plate, when the web is held stationary with respect to the support plate. In this way, tension control of the web by the friction-based tensioning device is further improved. The friction force provided by the friction-based tensioning device to the web supports reliable and accurate positioning of the web at the processing unit, when the web is transported by the transport device in the transport direction.

In an embodiment, the plurality of suction holes comprises separate segments partitioned along a transverse direction arranged across to the transport path, and wherein a suction force provided to the web at each of the segments is controllable independently of one another. As the suction force is controllable for each of the segments independently of one another, the friction force to the web is controllable at each of the segments along the transverse direction independently of one another. As a result, the tension of the web in the transport direction can be adjusted for each segment along the transverse direction independently of one another. In this way, any tension variations of the web along the transverse direction can be minimized. In an example of the embodiment, the web may be steered by the friction-based tensioning device with respect to the transport path, such as skewed by providing a gradient in a tension of the web along the transverse direction.

In yet another example of the embodiment, a first segment of suction holes is arranged for tensioning a first web and a second segment of suction holes is arranged for tensioning a second web, which is arranged alongside of the first web. The friction-based tensioning device of this embodiment supports a tandem processing of a first web and a second web alongside of one another while controlling a tension of each web independently of one another.

In an embodiment, the guiding surface is substantially stationary arranged with respect to the transport path and wherein the tension of the web is controlled by a sliding movement of the web along the guiding surface in response to the friction force provided to the contact side of the web at the guiding surface. The guiding surface is stationary arranged with respect to the transport path and the web makes a sliding movement along the guiding surface, when the web is moved in the transport direction by the transport device, in response to the friction force provided by the guiding surface. In this way, the tension of the web in the transport direction is controlled by the friction force provided to the contact side of the web at the guiding surface.

In an embodiment, the friction-based tensioning device comprises a rotatable roller comprising the guiding surface at its circumference; and wherein the friction-based tensioning device further comprises a friction mechanism coupled to the rotatable roller and configured for controlling a friction force for restraining a rotation of the roller around its rotation axis. The friction force provided to the rotatable roller by the friction mechanism, such as a journal bearing assembly or a plain bearing assembly, restrains the rotation of the roller around its rotation axis. The guiding surface of the roller is in rolling contact to the contact side of the web while controlling the tension of the web by the friction force acting on the roller. In examples, the friction mechanism, such as a journal bearing assembly or a plain bearing assembly, may be coupled to a shaft of the roller and may be coupled to a portion of the outer circumference of the roller. As a result, said friction mechanism, which restraining a rotation of the roller around its rotation axis, controls the tension of the web between the friction-based tensioning device and the transport device. In this embodiment, the friction force acting on the contact side of the web via the guiding surface is selected higher than the friction force acting on the roller, which restrains the rotation of the roller. As such, the web pulls the roller, thereby driving a rotation of the roller around its rotating axis, while the web is moved in the transport direction along the transport path by the transport device.

In an embodiment, the friction-based tensioning device comprises a rotatable lever assembly comprising a shaft coinciding with a rotation axis of the lever assembly, a guiding plate comprising the guiding surface, a lever element arranged for connecting the guiding plate to the shaft and a spring mechanism coupled to the lever assembly and configured for controlling a torque force for restraining a rotation of the guiding plate around the rotation axis. The spring mechanism controls a torque force acting on the lever assembly, which torque force is directed to restrain a rotation of the guiding plate around rotation axis. The torque force provided by the spring mechanism depends on a rotation angle of the lever element, including the guiding plate, about the rotation axis of the lever assembly. The web is attracted to the guiding surface of the guiding plate by a suction force provided to the contact side of the web.

In case the web is moved in the transport direction by the transport device, the guiding plate is moved by the web in an arched way along the transport path by rotation about the rotation axis. As a result, the torque force provided by the spring mechanism to the lever assembly increases, thereby increasing the tension of the web in the transport direction. At the point the tension of the web reaches to a level equal to the friction force provided at the guiding surface, the web starts to slide along the guiding surface. As a consequence, the tension of the web is controlled to be substantially constant, while the guiding plate is held substantially stationary with respect to the transport path, i.e. at a constant rotation angle about the rotations axis, by the spring mechanism.

The tension of the web can be easily adjusted by adjusting the suction force provided to the web at the guiding surface. When adjusting the suction force to adjust the friction force, the rotatable lever assembly will obtain another rotation angle about the rotation axis, which rotation angle corresponds to the torque force of the spring mechanism being substantially equal to the friction force provided at the guiding surface. As such, a rotation angle of the lever element provides a measure of the torque force of the spring mechanism and, consequently, of a tension of the web in the transport direction.

In an embodiment, the rotatable roller comprises separate roller segments partitioned along a transverse direction arranged across to the transport path, and wherein the friction mechanism is arranged to control a friction force provided to each of the roller segments independently of one another. Each of the roller segments has a guiding surface for contacting the contact side of the web, wherein a suction force is provided to control a friction of the roller segment to the contact side of the web. The friction mechanism controls a friction force provided to each of the roller segments independently of one another. In an example, the friction mechanism comprises a plurality of bearing elements, each bearing element being arranged in contact to one of the roller segments for controlling the friction force. As such, each segment of the roller is rotatable independently of one another.

In this way, the tension of the web in the transport direction may be varied along the transverse direction by the friction mechanism, i.e. by controlling each of the roller segments.

In an embodiment, the rotatable lever assembly comprises separate lever segments partitioned along a transverse direction arranged across to the transport path, and wherein the spring mechanism is arranged to control a torque force provided to each of the lever segments independently of one another. Each of the lever segments comprises a lever element and a guiding plate having a guiding surface for contacting the contact side of the web, wherein a suction force is provided to control a friction of the guiding plate to the contact side of the web. The spring mechanism controls a torque force provided to each of the lever segments independently of one another. In an example, the spring mechanism comprises a plurality of spring elements, each spring element being connected to one of the guide plates for controlling the torque force provided to the guide plate, respectively. As such, each segment of the lever assembly is rotatable around the rotation axis independently of one another.

In this way, the tension of the web in the transport direction may be varied along the transverse direction by the spring mechanism, i.e. by controlling each of the lever segments independently one another.

In an embodiment, the friction-based tensioning device comprises a rotation angle measuring device arranged for measuring a rotation angle of the lever element about the rotation axis of the lever assembly to determine the tension of the web. The rotation angle measuring device may comprise a rotation scale for indicating a rotation angle of the lever element about the rotation axis. The rotation scale may be configured to be readable by an operator. The rotation angle of the lever element about the rotation axis is a measure of the tension of the web in the transport direction.

In an example, the friction-based tensioning device comprises a lever assembly comprising a first lever segment and a second lever segment arranged adjacent one another; and a first rotation angle measuring device arranged for measuring a rotation angle of the first lever segment and a second rotation angle measuring device arranged for measuring a rotation angle of the second lever segment. In this way, a tension of a first side, e.g. left hand side, of the web may be measured by use of the first rotation angle measuring device and a tension of a second side, e.g. right hand side, of the web may be measured by use of the second rotation angle measuring device.

In an embodiment, the guiding surface has a curved shape for bending the web along the transport path towards the processing unit. In example, the guiding surface is provided by a turn bar for turning a web, such as a web coming from below a processing unit towards a path along the processing unit, such as a transport path arranged along a support plate of the processing unit. The guiding surface, such as provided by the turn bar, may be arranged substantially at a same height level with respect to a gravity direction as the height level of the support plate of the processing unit.

In this way, the guiding surface may also be used for holding the web at substantially the same height level with respect to a gravity direction as the support plate of the processing unit. Furthermore, the guiding surface may be used as a pick-up surface for holding parts of the web by providing a suction force at the guiding surface, while manually loading the web from a roll into the transport path by unrolling the web from the roll. This arrangement supports easy manually loading of the web into the transport path even when the web has a large width in a transverse direction across the transport path.

In examples, the turn bar may be arranged stationary with respect to the transport path and the turn bar may be rotatably arranged around a rotation axis arranged across the transport path, wherein the turn bar has the guiding surface arranged at its circumference.

In an embodiment, the transport device is configured for moving the web intermittently along the processing unit. The embodiment supports processing of the web, while the web is held stationary with respect to the transport path. The friction-based tensioning device enables accurate tension control of the web, wherein the transport device moves the web intermittently in the transport direction along the processing unit. In an example, the friction-based tensioning device may be configured to adjust the friction force provided by the guiding surface to the web dependent on the movement of the web. The friction force may be easily and quickly adjusted by the friction-based tensioning device by changing the suction force provided at the guiding surface.

In another aspect of the present invention printer apparatus is provided comprising the web transport assembly according to the present invention, wherein the processing unit comprises a print head assembly configured for forming an image on the web.

The print head assembly may be mounted on a carriage for a scan wise movement over the web across the transport path. The printer apparatus provides improved control on the tension of the web during transport along the print head assembly while reducing complexity of the web transport assembly. For example, no additional dancer assembly is required to accurately control the tension of the web along the transport path at the processing unit.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1A shows an image forming apparatus, wherein printing is achieved using a wide format inkjet printer.

FIG. 1B shows an ink jet printing assembly.

FIGS. 2A and 2B show schematically an embodiment of a web transport assembly for transporting a web along a processing unit according to the present invention.

FIGS. 3A and 3B show schematically another embodiment of a web transport assembly for transporting a web along a processing unit according to the present invention.

FIGS. 4A-4B show schematically another embodiment of a web transport assembly for transporting a web along a processing unit according to the present invention.

FIG. 5 shows a modified friction-based tensioning device of the embodiment shown in FIGS. 4A-4B.

FIG. 6 shows a plane view of another modified friction-based tensioning device of the embodiment shown in FIGS. 4A-4B.

FIG. 7 show schematically another embodiment of a web transport assembly for transporting a web along a processing unit according to the present invention.

FIG. 8 shows a plane view of a modified friction-based tensioning device of the embodiment shown in FIG. 7.

### DETAILED DESCRIPTION OF THE DRAWINGS

The present invention will now be described with reference to the accompanying drawings, wherein the same reference numerals have been used to identify the same or similar elements throughout the several views.

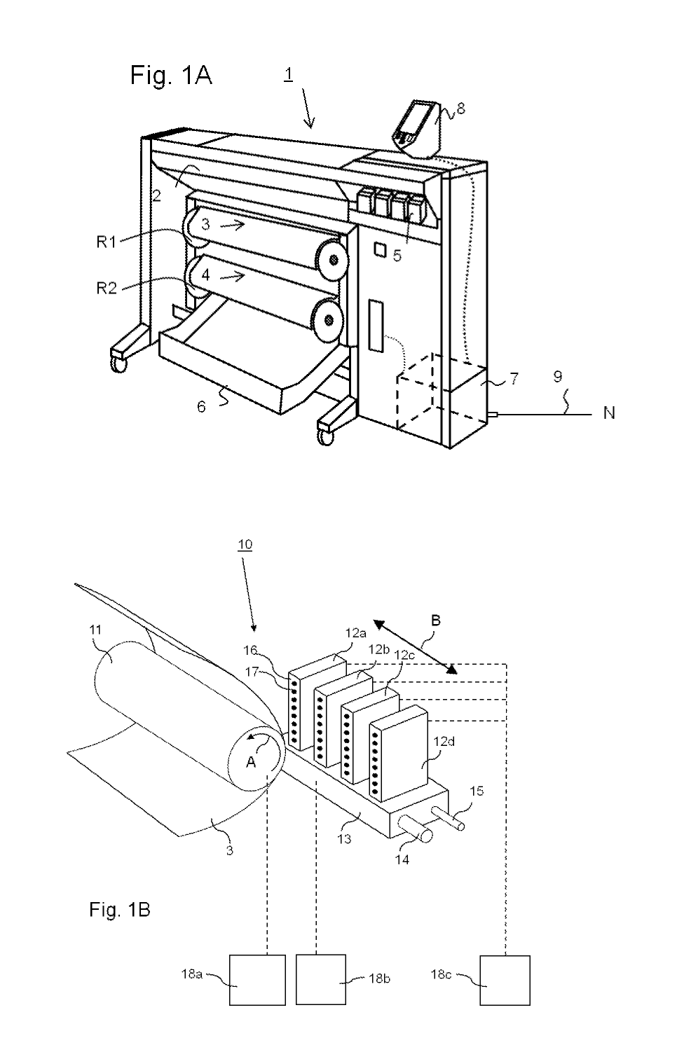

FIG. 1A shows an image forming apparatus 1, wherein printing is achieved using a wide format inkjet printer. The wide-format image forming apparatus 1 comprises a housing 2, wherein the printing assembly, for example the ink jet printing assembly shown in FIG. 1B is placed. The image forming apparatus 1 also comprises a storage means for storing image receiving member 3, 4, a delivery station to collect the image receiving member 3, 4 after printing and storage means 5 for marking material. In FIG. 1A, the delivery station is embodied as a delivery tray 6. Optionally, the delivery station may comprise processing means for processing the image receiving member 3, 4 after printing, e.g. a folder or a puncher. The wide-format image forming apparatus 1 furthermore comprises means for receiving print jobs and optionally means for manipulating print jobs. These means may include a user interface unit 8 and/or a control unit 7, for example a computer.

Images are printed on an image receiving member, for example paper, supplied by a roll 3, 4. The roll 3 is supported on the roll support R1, while the roll 4 is supported on the roll support R2. Alternatively, cut sheet image receiving members may be used instead of rolls 3, 4 of image receiving member. Printed sheets of the image receiving member, cut off from the roll 3, 4, are deposited in the delivery tray 6.

Each one of the marking materials for use in the printing assembly are stored in four containers 5 arranged in fluid connection with the respective print heads for supplying marking material to said print heads.

The local user interface unit 8 is integrated to the print engine and may comprise a display unit and a control panel. Alternatively, the control panel may be integrated in the display unit, for example in the form of a touch-screen control panel. The local user interface unit 8 is connected to a control unit 7 placed inside the printing apparatus 1. The control unit 7, for example a computer, comprises a processor adapted to issue commands to the print engine, for example for controlling the print process. The image forming apparatus 1 may optionally be connected to a network N. The connection to the network N is diagrammatically shown in the form of a cable 9, but nevertheless, the connection could be wireless. The image forming apparatus 1 may receive printing jobs via the network. Further, optionally, the controller of the printer may be provided with a USB port, so printing jobs may be sent to the printer via this USB port.

FIG. 1B shows an ink jet printing assembly 10. The ink jet printing assembly 10 comprises supporting means for supporting an image receiving member 3. The supporting means 11 are shown in FIG. 1B as a platen 11, but alternatively, the supporting means 11 may be a flat surface. The platen 11, as depicted in FIG. 1B, is a rotatable drum 11, which is rotatable about its axis as indicated by arrow A. The supporting means 11 may be optionally provided with suction holes for holding the image receiving member 3 in a fixed position with respect to the supporting means 11. The inkjet printing assembly 10 comprises print heads 12a-12d, mounted on a scanning print carriage 13. The scanning print carriage 13 is guided by suitable guiding means 14, 15 to move in reciprocation in the main scanning direction B. Each print head 12a-12d comprises an orifice surface 16, which orifice surface 16 is provided with at least one orifice 17. The print heads 12a-12d are configured to eject droplets of marking material onto the image receiving member 3. The platen 11, the carriage 13 and the print heads 12a-12d are controlled by suitable controlling means 18a, 18b and 18c, respectively.

The image receiving member 3 may be a medium in web or in sheet form and may be composed of e.g. paper, cardboard, label stock, coated paper, plastic, canvas, film or textile. Alternatively, the image receiving member 3 may also be an intermediate member, endless or not. Examples of endless members, which may be moved cyclically, are a belt or a drum. The image receiving member 3 is moved in the sub-scanning direction A by the platen 11 along four print heads 12a-12d provided with a fluid marking material. A scanning print carriage 13 carries the four print heads 12a-12d and may be moved in reciprocation in the main scanning direction B parallel to the platen 11, such as to enable scanning of the image receiving member 3 in the main scanning direction B. Only four print heads 12a-12d are depicted for demonstrating the invention. In practice an arbitrary number of print heads may be employed. In any case, at least one print head 12a-12d per color of marking material is placed on the scanning print carriage 13. For example, for a black-and-white printer, at least one print head 12a-12d, usually containing black marking material is present. Alternatively, a black-and-white printer may comprise a white marking material, which is to be applied on a black image-receiving member 3. For a full-color printer, containing multiple colors, at least one print head 12a-12d for each of the colors, usually black, cyan, magenta and yellow is present. Often, in a full-color printer, black marking material is used more frequently in comparison to differently colored marking material. Therefore, more print heads 12a-12d containing black marking material may be provided on the scanning print carriage 13 compared to print heads 12a-12d containing marking material in any of the other colors. Alternatively, the print head 12a-12d containing black marking material may be larger than any of the print heads 12a-12d, containing a differently colored marking material.

The carriage 13 is guided by guiding means 14, 15. These guiding means 14, 15 may be rods as depicted in FIG. 1B. The rods may be driven by suitable driving means (not shown). Alternatively, the carriage 13 may be guided by other guiding means, such as an arm being able to move the carriage 13. Another alternative is to move the image receiving material 3 in the main scanning direction B.

Each print head 12a-12d comprises an orifice surface 16 having at least one orifice 17, in fluid communication with a pressure chamber containing fluid marking material provided in the print head 12a-12d. On the orifice surface 16, a number of orifices 17 is arranged in a single linear array parallel to the sub-scanning direction A. Eight orifices 17 per print head 12a-12d are depicted in FIG. 1B, however obviously in a practical embodiment several hundreds of orifices 17 may be provided per print head 12a-12d, optionally arranged in multiple arrays. As depicted in FIG. 1B, the respective print heads 12a-12d are placed parallel to each other such that corresponding orifices 17 of the respective print heads 12a-12d are positioned in-line in the main scanning direction B. This means that a line of image dots in the main scanning direction B may be formed by selectively activating up to four orifices 17, each of them being part of a different print head 12a-12d. This parallel positioning of the print heads 12a-12d with corresponding in-line placement of the orifices 17 is advantageous to increase productivity and/or improve print quality. Alternatively multiple print heads 12a-12d may be placed on the print carriage adjacent to each other such that the orifices 17 of the respective print heads 12a-12d are positioned in a staggered configuration instead of in-line. For instance, this may be done to increase the print resolution or to enlarge the effective print zone, which may be addressed in a single scan in the main scanning direction. The image dots are formed by ejecting droplets of marking material from the orifices 17.

Upon ejection of the marking material, some marking material may be spilled and stay on the orifice surface 16 of the print head 12a-12d. The ink present on the orifice surface 16, may negatively influence the ejection of droplets and the placement of these droplets on the image receiving member 3. Therefore, it may be advantageous to remove excess of ink from the orifice surface 16. The excess of ink may be removed for example by wiping with a wiper and/or by application of a suitable anti-wetting property of the surface, e.g. provided by a coating.

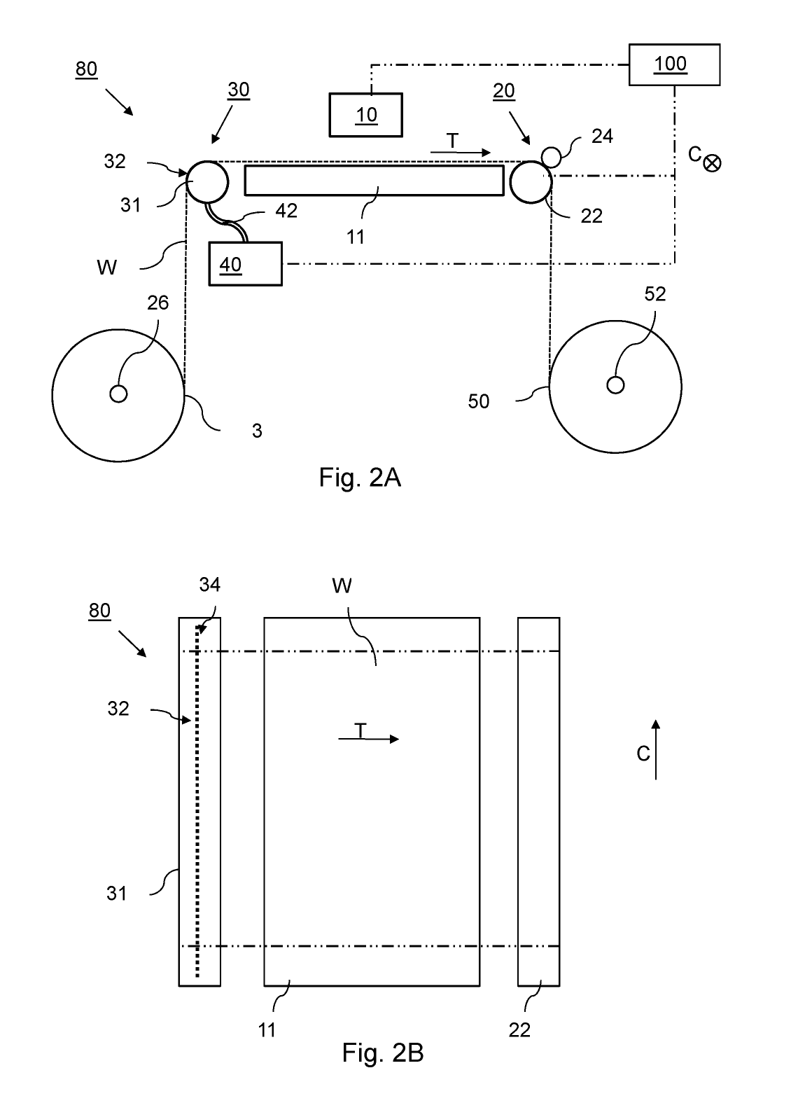

FIGS. 2A and 2B show schematically an embodiment of a web transport assembly for transporting a web along a processing unit according to the present invention. The web transport assembly 80 may be used in a printing apparatus 1 shown in FIGS. 1A-1B. FIG. 2A shows a side view of the web transport assembly 80. FIG. 2B shows a plane view on the web transport assembly 80. The web transport assembly 80 comprises a transport device 20, which is a nip comprising a driven roller 22 and a pressure roller 24, and a friction-based tensioning device 30. The transport device 20 is arranged downstream of a processing unit 10, such as a print head assembly, and transports a web W along a transport path in a transport direction T. The web is supplied from a roll 3, which is supported by a spindle 26. The web is moved by the transport nip 20 along the transport path from the supply roll 3 along the friction-based tensioning device 30, the processing unit 10 towards a receiving roll 50. The receiving roll 50 is supported on a spindle 52. The print head assembly 10 faces a support plate 11, which is arranged to attract the web to the support plate by applying a suction force to a contact side of the web W. The web transport assembly further comprises a control unit 100, which is operatively connected to the print head assembly 10 and to the transport device 20.

The friction-based tensioning device 30 is arranged upstream of the support plate 10 and comprises a turn element 31 comprising a guiding surface 32 for guiding a contact side of the web W while bending the web towards a path over the support plate 11 along the print head assembly 10. The guiding surface 32 comprises an array of suction holes 34 arranged along a transverse direction C across to the transport path, which extends in the transport direction T. The friction-based tensioning device 30 is operatively coupled to a suction source 40, such as a suction pump, via a tube 42, which communicates a suction pressure to the array of suction holes 34 via a manifold, which is enclosed in the turn element 31. The control unit 100 is operatively connected to the suction source 40 for controlling a suction pressure provided to the contact side of the web via the suction holes 34.

The guiding surface 32 exerts a friction force onto the contact side of the web W, wherein the friction force is provided in response to the suction force provided to the contact side of the web via the suction holes 34. The friction-based tensioning device 30 is configured for controlling a tension of the web W along the transport path between the guiding surface 32 of the friction-based tensioning device 30 and the transport nip 20. In transport operation, the transport nip 20 transports the web W along the transport path in the transport direction T, such as by intermittently moving the web W in the transport direction T. As the transport nip 20 drives the web W in the transport direction T, the friction-based tensioning device 30 controls the tension of the web W in the transport direction T by controllably restraining the web in the transport direction T.

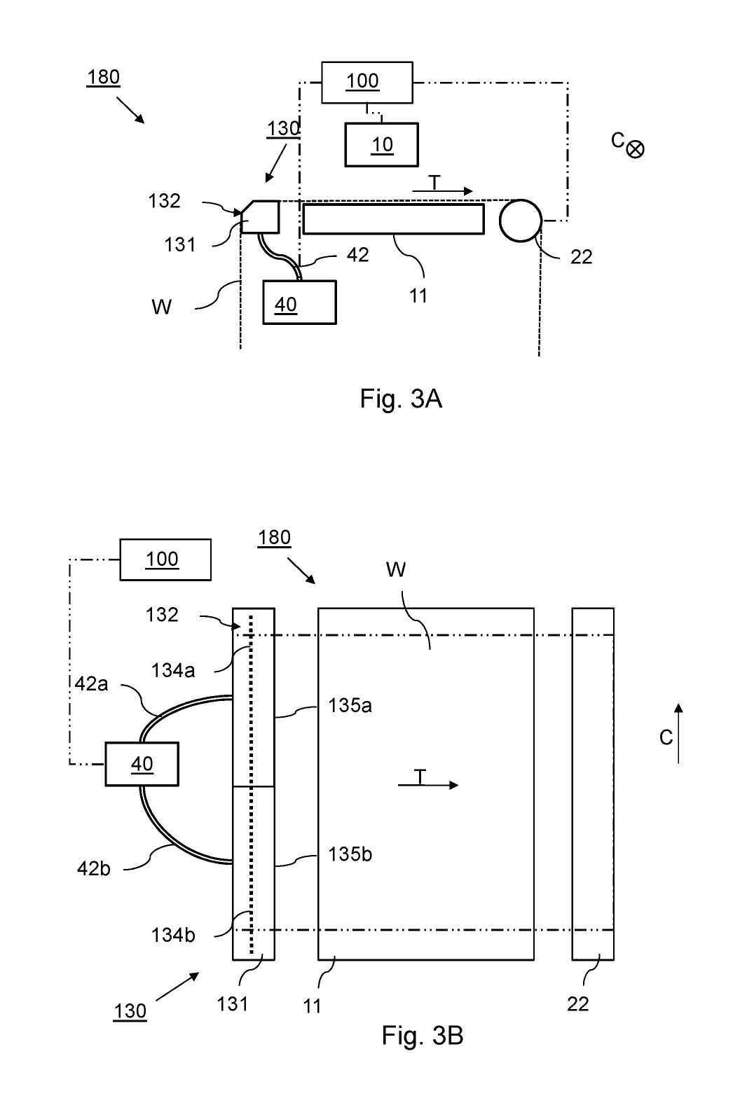

FIGS. 3A and 3B show schematically another embodiment of a web transport assembly for transporting a web along a processing unit according to the present invention. The web transport assembly 180 may be used in a printing apparatus 1 shown in FIGS. 1A-1B.

FIG. 3A shows an enlarged side view of the web transport assembly 180. FIG. 3B shows a plane view on the web transport assembly 180. The web transport assembly 180 comprises a transport roller 22, a friction-based tensioning device 130 and a control unit 100. The transport roller 22 is a driven roller, which is controlled by the control unit 100, for transporting the web w along a transport path in a transport direction T along a processing unit 10, which faces a support plate 11.

The friction-based tensioning device 130 comprises a turn bar 131, which is stationary arranged relative to the transport path and comprises a guiding surface 132 for guiding a contact side of the web W while bending the web towards a path over the support plate 11 along the processing unit 10. The guiding surface 132 comprises a plurality of suction holes 134a-134b arranged along a transverse direction C across to the transport path, which extends in the transport direction T.

The plurality of suction holes 134a-134b comprises two segments 134a-134b arranged adjacent one another along the transverse direction C. Each segment 134a-134b of the plurality of suction holes is connected to a manifold 135a-135b, respectively, which is provided inside the turn bar 131 and arranged adjacent one another along the transverse direction C.

Each manifold 135a-135b is of the friction-based tensioning device 130 is operatively coupled to a suction source 40, such as a suction pump, via a tube 42a-42b, respectively, which communicates a suction pressure to the segment of suction holes 134a-134b via the manifold 135a-135b, which is enclosed in the turn element 131. The control unit 100 is operatively connected to the suction source 40 for controlling a suction pressure provided to the contact side of the web W via the segments of suction holes 134a-134b at each segment independently one another.

The guiding surface 132 exerts a friction force onto the contact side of the web W, wherein the friction force is provided in response to the suction force provided to the contact side of the web at each of the segments via the suction holes 134a-134b. As the suction force is controlled of each segments of the suction holes 134a-134b independently one another, the tension of the web W can be adjusted for each segment along the transverse direction C.

In an example, any differences in tension of the web W along the transverse direction C, such as due to variations of the web W and/or the guiding surface along the transverse direction C, can be minimized by applying different suction forces to the segments of the suction holes 134a-134d.

Alternatively or additionally, a difference in tension of the web W along the transverse direction C may be induced by applying different suction forces to the segments of the suction holes 134a-134d in order to steer the web W with respect to the transport path. In an example, suction force by the left manifold segment 135a may be increased relative to the right manifold segment 135b. As a result, the friction induces on the web W by the guiding surface 132 at the segment 135a is higher than the friction induces on the web W by the guiding surface 132 at the segment 135b. In this way, the tension of the web W at the left side is higher than the tension of the web W at the right side, relative to the transport direction T, thereby rotating the web C counter-clockwise when looking from above in the plane view of FIG. 3B.

In yet another use of the web transport assembly 180 (not shown), a first web and a second web may be transported alongside one another along the transport path. The first web may be arranged at the left side of the transport path in contact with the guiding surface 132 at the segment of the suction holes 134a. The second web may be arranged at the right side of the transport path in contact with the guiding surface 132 at the segment of the suction holes 134b. The tension of the first web may be controlled by the segment of the suction holes 134a of the friction-based tensioning device 130, while the tension of the second web may be controlled by the segment of the suction holes 134b of the friction-based tensioning device 130. In this way, the friction-based tensioning device 130 supports a tandem processing of the first web and second web alongside one another while controlling a tension of each web independently one another.

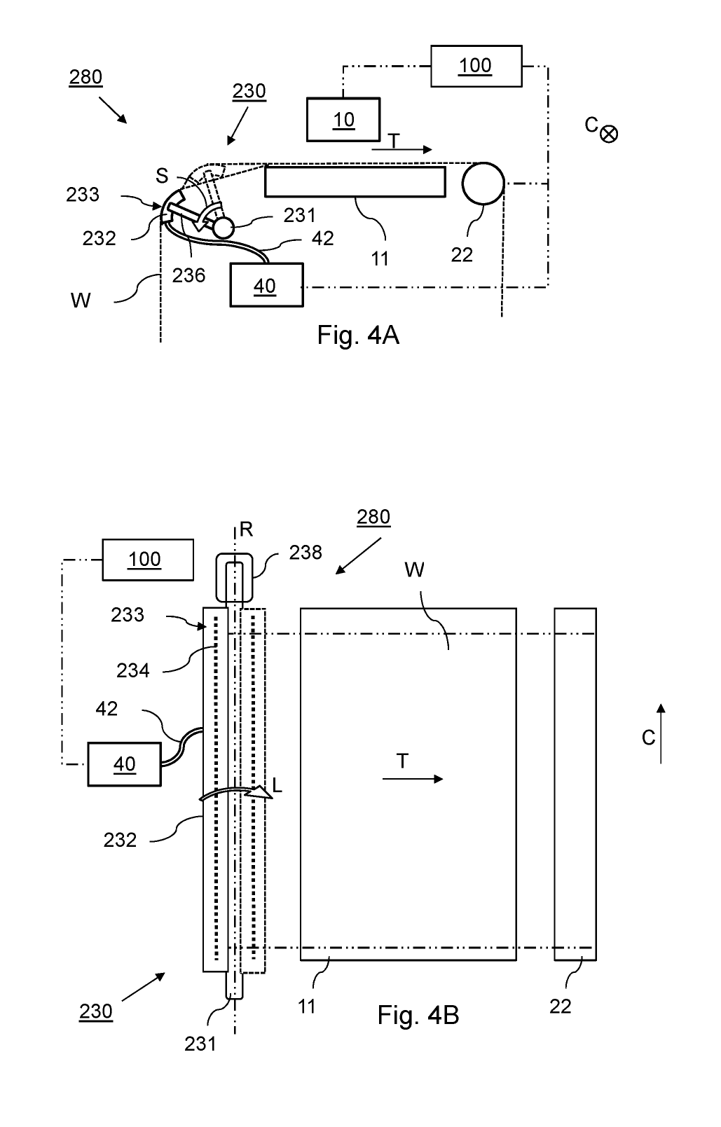

FIGS. 4A-4B show schematically another embodiment of a web transport assembly for transporting a web along a processing unit according to the present invention. The web transport assembly 280 may be used in a printing apparatus 1 shown in FIGS. 1A-1B.

FIG. 4A shows an enlarged side view of the web transport assembly 280. FIG. 4B shows a plane view on the web transport assembly 280. The web transport assembly 280 comprises a transport roller 22, a friction-based tensioning device 230 and a control unit 100. The transport roller 22 is a driven roller, which is controlled by the control unit 100, for transporting the web w along a transport path in a transport direction T along a processing unit 10, which faces a support plate 11.

The friction-based tensioning device 230 is a rotatable lever assembly, which comprises a shaft 231, a guiding plate 232, a lever element 236 and a spring mechanism 238 (shown in FIG. 4B). The shaft 231 coincides with a rotation axis R of the rotatable lever assembly 230. The rotation axis R is arranged extending parallel to the transverse direction C across to the transport path. The guiding plate 232 comprises a guiding surface 233 for guiding a contact side of the web W. The lever element 236 connects the guiding plate 232 to the shaft 231. As such, the guide plate 232 is rotatably arranged around the rotation axis R of the rotatable lever assembly 230. The guiding plate 232 is rotatable around the rotation axis between a first rotation position (solid line) and a second rotation position (dashed line).

The spring mechanism 238 is coupled to the lever assembly 230 via the shaft 231 and exerts a torque force onto the guiding plate 232 via the lever element 236. The torque force depends on the rotation angle of the lever element 236 around the rotation axis. Furthermore, the torque force depends on a length of the lever element 236 between the shaft 231 and the guiding plate 232. The torque force is directed in a direction as indicated by arrow S such to restrain a rotation of the guiding plate 232.

The guiding surface 233 is arranged for guiding a contact side of the web W while bending the web towards a path over the support plate 11 along the processing unit 10. The guiding surface 233 comprises an array of suction holes 234 arranged along a transverse direction C across to the transport path, which extends in the transport direction T. Alternatively, the guiding surface 233 may comprise a plurality of arrays of suction holes 234 (not shown), each array being arranged along a transverse direction C across to the transport path.

The friction-based tensioning device 230 is operatively coupled to a suction source 40, such as a suction pump, via a tube 42, which communicates a suction pressure to the array of suction holes 234 via a manifold, which is enclosed in the guiding plate 232. The control unit 100 is operatively connected to the suction source 40 for controlling a suction pressure provided to the contact side of the web via the suction holes 234. The web W is attracted to the guiding surface 233 of the guiding plate 232 by a suction force provided to the contact side of the web. In case the web W is moved in the transport direction T by the transport roller 22, the guiding plate 232 of the lever assembly 230 moves in an arched way long the transport path by rotation about the rotation axis as schematically indicated by arrow L in FIG. 4, such as from the first rotation position (solid line) to the second rotation position (dashed line). As a result, the torque force provided by the spring mechanism 238 increases, thereby increasing the tension of the web W in the transport direction T.

At the rotation position of the guiding plate 232, where the tension of the web W reaches a level equal to the friction force provided at the guiding surface 233 to the contact side of the web W, the web W starts sliding along the guiding plate 232 in the transport direction. As a result, the tension of the web is controlled to be constant, while the guiding plate 232 is held substantially stationary with respect to the transport path, thus at a constant rotation angle about the rotation axis. At this rotation angle the torque force at the guiding surface 233 of the guiding plate 232 is equal to and in opposite direction to the friction force applied by the guiding surface 233 to the web W.

The tension of the web W can easily be adjusted by adjusting the suction force provided to the web W at the guiding surface 233. When the suction force is adjusted, such as decreased, the friction force applied by the guiding surface 233 to the web W decreases. As a result, the spring element 238 will rotate the guiding plate 232 counter-clock wise (as shown in FIG. 4A). Thereby, the torque force provided by the spring mechanism 238 will decrease accordingly. The guiding plate 232 and the lever element 236 will obtain another rotation angle about the rotation axis, wherein a lower torque force balances the lower friction force at the guiding surface 233. As such, a rotation angle of the lever element 236 provides a measure of the torque force of the spring mechanism 238 and, when the web is engaged by the guiding surface 233, of the tension of the web W in the transport direction T.

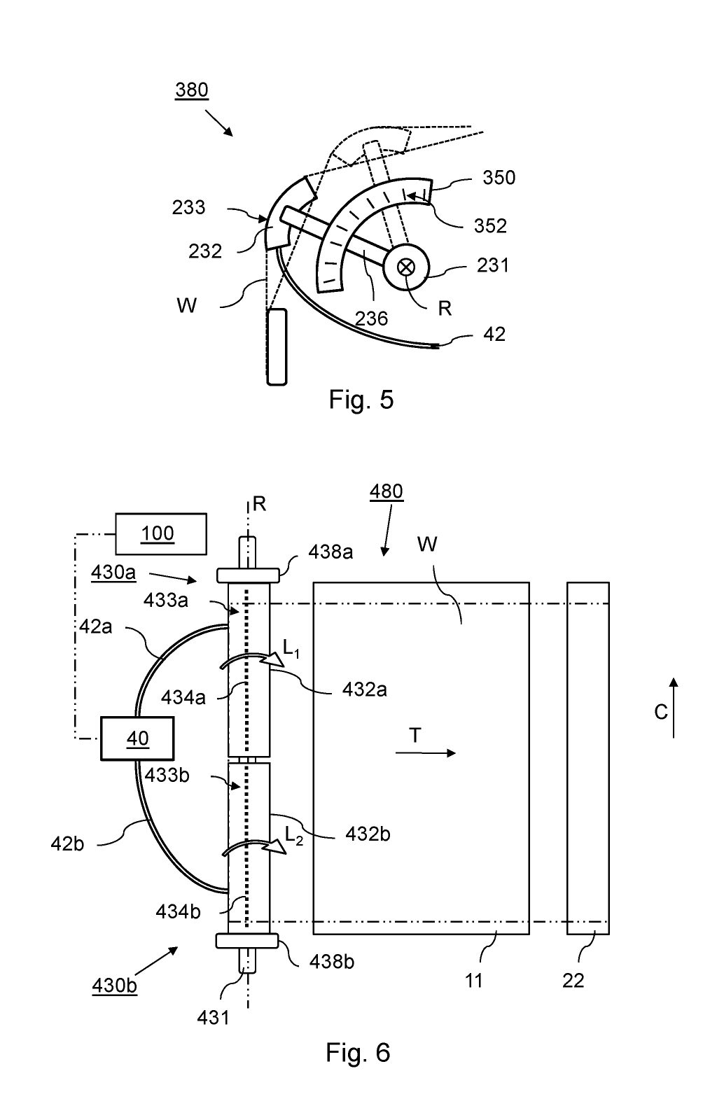

FIG. 5 shows a modified friction-based tensioning device of the embodiment shown in FIGS. 4A-4B. FIG. 5 shows an enlarged side view of the web transport assembly 380. The modified friction-based tensioning device 330 comprises the lever assembly shown in FIGS. 4A-4B and additionally comprises a rotation angle measuring device 350. The rotation angle measuring device 350 comprises a rotation scale 352 mounted to the lever assembly 330. The rotation scale 352 comprises a plurality of marks for indicating a rotation angle of the lever element 236 including the guiding plate 232 about the rotation axis R which coincides with the shaft 231. The rotation scale 352 is configured to be readable by an operator. The rotation angle of the lever element 236 about the rotation axis R is a measure of the tension of the web w in the transport direction T.

In an alternative example, the lever assembly 330 may be provided with a rotatable encoder and a sensor (not shown). The rotatable encoder is mounted on the shaft 231 and comprises a plurality of marks for indicating a rotation angle of the lever element 236 including the guiding plate 232 about the rotation axis R which coincides with the shaft 231. The sensor is arranged for detecting the marks on the rotatable encoder and to send a sensor signal to the control unit 100 for indicating the rotation angle of the lever element 236 including the guiding plate 232 about the rotation axis R. In this way, the control unit 100 may determine the tension of the web W based on the detected rotation angle of the lever element 236.

FIG. 6 shows a plane view of another modified friction-based tensioning device of the embodiment shown in FIGS. 4A-4B. The modified friction-based tensioning device 430 comprises the rotatable lever assembly 330 shown in FIGS. 4A-4B, wherein the lever assembly 430 comprises a shaft 431, a first lever segment 430a and a second lever segment 430b. The first lever segment 430a and a second lever segment 430b are arranged alongside one another in the transverse direction C across to the transport path. Each of the first lever segment 430a and a second lever segment 430b is rotatable around the shaft 431 independently one another, as schematically indicated by arrows L₁ and L₂ in FIG. 6.

Each lever segment 430a-403b comprises a lever element (as shown in FIG. 4A) and a guiding plate 432a-432b. The lever element connects the guiding plate 432a-432b to the shaft 231. Each guiding plate 432a-432b comprises a guiding surface 433a-433b for guiding the web W and a plurality of suction holes 434a-434b for providing a suction force to a contact side of the web W to control a friction force of the guiding surface 433a-433b, respectively, to the web W. The spring mechanism 438 controls a torque force provided to each of the lever segments 430a-403b around the rotation axis R, which coincides with the shaft 431, independently one another by way of a spring element 438a-438b, respectively, which is connected to one of the lever elements (shown in FIG. 4A), respectively.

Each guide plate 432a-432b is operatively coupled to a suction source 40, such as a suction pump, via a tube 42a-42b, respectively, which communicates a suction pressure to the segment of suction holes 434a-434b, respectively. The control unit 100 is operatively connected to the suction source 40 for controlling a suction pressure provided to the contact side of the web W via the suction holes 434a-434b at each lever segment independently one another.

The guiding surface 433a-433b of each lever segment exerts a friction force onto the contact side of the web W, wherein the friction force is provided in response to the suction force provided to the contact side of the web at each of the lever segments via the suction holes 434a-434b.

As the suction force is controlled of the suction holes 434a-434b of each lever segment 430a-430b independently one another, the tension of the web W can be adjusted for each lever segment 430a-430b along the transverse direction C.

In this way, the tension of the web W in the transport direction T may be varied along the transverse direction C by the spring mechanism 438.

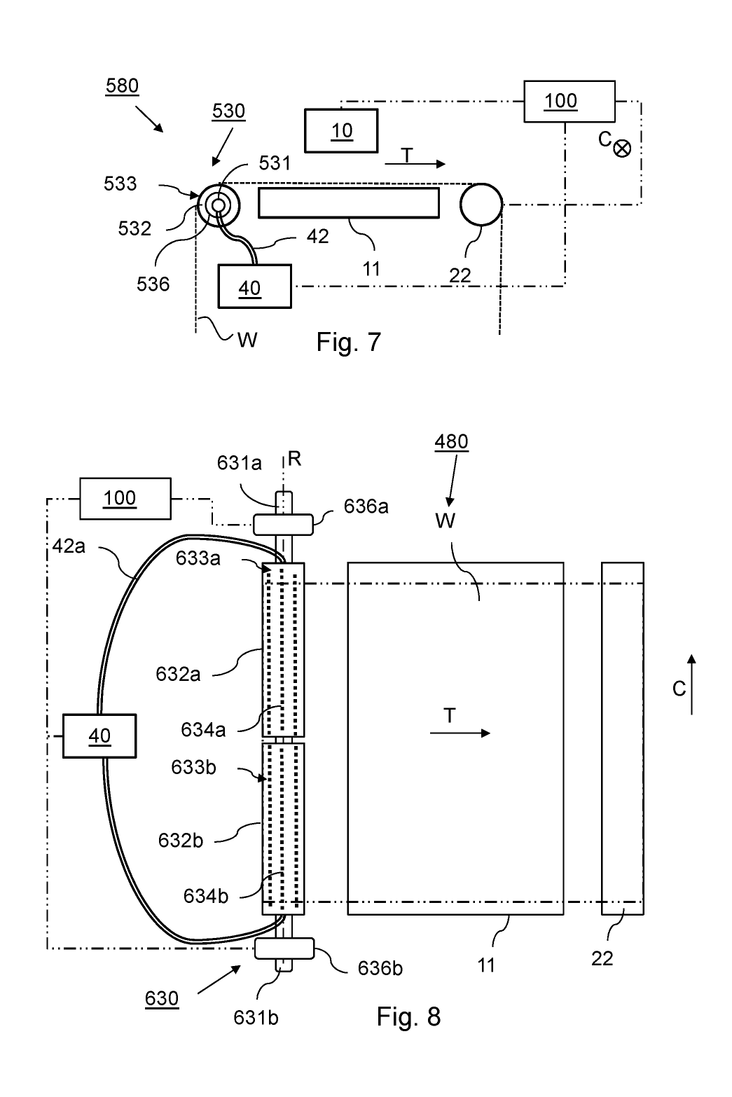

FIG. 7 show schematically another embodiment of a web transport assembly for transporting a web along a processing unit according to the present invention. The web transport assembly 580 may be used in a printing apparatus 1 shown in FIGS. 1A-1B.

FIG. 7 shows an enlarged side view of the web transport assembly 580. FIG. 4B shows a plane view on the web transport assembly 580. The web transport assembly 580 comprises a transport roller 22, a friction-based tensioning device 530 and a control unit 100. The transport roller 22 is a driven roller, which is controlled by the control unit 100, for transporting the web W along a transport path in a transport direction T along a processing unit 10, which faces a support plate 11.

The friction-based tensioning device 530 is a rotatable roller 532 comprising a guiding surface 533 at its circumference. The roller 532 is mounted on a shaft 531, which coincides with the rotation axis of the roller 532. The roller 532 further comprises suction holes 534 distributed over the guiding surface 533 for providing a suction force to a contact side of the web W, while the guiding surface 533 of the roller 530 is in rolling contact to the contact side of the web W. For this purpose, the suction holes 534 are distributed over the guiding surface 533 along the circumference direction of the roller 530.

The suction holes 533 are connected to a suction source 40 via a tube 42. The suction source 40 provides a suction pressure to the suction holes 534 for attracting the web onto the guiding surface 533. The control unit 100 is operatively connected to the suction source 40 for controlling a suction pressure provided to the contact side of the web via the suction holes 534.

The friction-based tensioning device 530 further comprises a friction mechanism 536 coupled to the shaft 531 of the rotatable roller 532. The friction mechanism 536 is a journal bearing, which is configured for controlling a friction force acting on the shaft 531 for restraining a rotation of the roller 532 around its rotation axis. The control unit 100 is operatively connected to the friction mechanism 536 for controlling the friction force acting on the shaft 531.

The friction force provided to the contact side of the web W via the guiding surface 533 is selected higher than the friction force provided by the friction mechanism 536 onto the shaft 531 of the roller 532. As such, the web pulls the roller 532, thereby driving a rotation of the roller 532 around its rotating axis, when the web W is moved in the transport direction T along the transport path by the transport roller 22.

In this way, the friction mechanism 536 determines the tension of the web W, when the roller 532 is held in rolling contact to the contact side of the web W.

FIG. 8 shows a plane view of a modified friction-based tensioning device of the embodiment shown in FIG. 7. In the modified friction-based tensioning device 630, the rotatable roller 630 comprises a first roller segment 632a and a second roller segment 632b. The first roller segment 632a and a second roller segment 632b are arranged alongside one another along a transverse direction C across to the transport path. The first roller segment 632a and a second roller segment 632b are rotatably mounted on a first shaft 631a and a second shaft 631b independently one another. The first shaft 631a and second shaft 631b are both arranged coinciding with a mutual rotation axis R. Each of the roller segments 632a-632b has a guiding surface 633a-633b arranged at its circumference and comprises suction holes 634a-634b distributed over the guiding surface 633a-633b over the whole circumference of the roller segments 632a-632b, respectively, for providing a suction force to a contact side of the web W. The suction holes 634a-634b are connected to a suction source 40 via a tube 42a-42b, respectively. The suction source 40 provides a suction pressure to the suction holes 634a-634b for attracting the web onto the guiding surface 633a-633b. The control unit 100 is operatively connected to the suction source 40 for controlling a suction pressure provided to the contact side of the web via the suction holes 634a-634b of the first roller segment 632a and a second roller segment 632b independently one another.

The friction-based tensioning device 630 comprises a first journal bearing 636a and a second journal bearing 636b. The first journal bearing 636a is coupled to the first shaft 631a for control a friction force acting on the first shaft 631a for restraining a rotation of the first roller segment 632a. The second journal bearing 636b is coupled to the second shaft 631b for control a friction force acting on the second shaft 631b for restraining a rotation of the second roller segment 632b.

The control unit 100 is operatively connected to the first journal bearing 636a and the second journal bearing 636b for adjusting the friction force acting on the shafts 631a-631b, respectively, independently one another.

In this way, the tension of the web W in the transport direction T at both sides of the web W across the transport path may be controlled by each roller segment 632a-632b independently one another.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, it is contemplated that structural elements may be generated by application of three-dimensional (3D) printing techniques. Therefore, any reference to a structural element is intended to encompass any computer executable instructions that instruct a computer to generate such a structural element by three-dimensional printing techniques or similar computer controlled manufacturing techniques. Furthermore, such a reference to a structural element encompasses a computer readable medium carrying such computer executable instructions.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A web transport assembly for transporting a web along a processing unit for processing the web, the web transport assembly comprising:
a transport device arranged for moving the web in a transport direction through a transport path along the processing unit, the transport device being arranged downstream of the processing unit relative to the transport direction; and
a friction-based tensioning device arranged upstream of the processing unit relative to the transport direction;
wherein the friction-based tensioning device comprises a guiding surface for guiding the web towards the processing unit and a plurality of suction holes distributed over the guiding surface for providing a suction force to a contact side of the web, the plurality of suction holes being arranged in fluid communication to a suction source, which generates the suction force, wherein the guiding surface is configured to exert a friction force on the web in response to the suction force provided to the contact side of the web; and wherein the friction-based tensioning device is configured for controlling a tension of the web between the guiding surface and the transport device;
a control unit operatively coupled to the suction source to control the friction force provided to the contact side of the web;
a support plate for supporting the web at the processing unit, the support plate being configured for attracting the web to the support plate,
wherein the control unit is configured to control the suction force at the guiding surface, such that a friction force provided to the web by the guiding surface exceeds a friction force provided to the web by the support plate.

2. The web transport assembly according to claim 1, further comprising the suction source for providing a suction force to a contact side of the web via suction holes in the guiding surface and for providing a suction force to a contact side of the web via suction holes in the support plate, wherein the control unit is configured to control the suction force at the guiding surface to exceed the suction force at the support plate.

3. The web transport assembly according to claim 1, wherein the control unit is configured to control the attraction of the web to the support plate; and wherein the control unit is configured to adjust the attraction of the web to the support plate depending on a movement of the web by the transport device along the support plate.

4. The web transport assembly according to claim 1, wherein the plurality of suction holes comprises separate segments partitioned along a transverse direction arranged across to the transport path, and wherein a suction force provided to the web at each of the segments is controllable independently of one another.

5. The web transport assembly according to claim 1, wherein the guiding surface is stationary arranged with respect to the transport path and wherein the tension of the web is controlled by a sliding movement of the web along the guiding surface in response to the friction force provided to the contact side of the web at the guiding surface.

6. The web transport assembly according to claim 1, wherein the friction-based tensioning device comprises a rotatable roller comprising the guiding surface at its circumference; and wherein the friction-based tensioning device further comprises a friction mechanism coupled to the rotatable roller and configured for controlling a friction force for restraining a rotation of the roller around its rotation axis.

7. The web transport assembly according to claim 1, wherein the friction-based tensioning device comprises a rotatable lever assembly comprising a shaft coinciding with a rotation axis of the lever assembly, a guiding plate comprising the guiding surface, a lever element arranged for connecting the guiding plate to the shaft and a spring mechanism coupled to the lever assembly and configured for controlling a torque force for restraining a rotation of the guiding plate around the rotation axis.

8. The web transport assembly according to claim 7, wherein the rotatable roller comprises separate roller segments partitioned along a transverse direction arranged across to the transport path, and wherein the friction mechanism is arranged to control a friction force provided to each of the roller segments independently of one another.

9. The web transport assembly according to claim 8, wherein the rotatable lever assembly comprises separate lever segments partitioned along a transverse direction arranged across to the transport path, and wherein the spring mechanism is arranged to control a torque force provided to each of the lever segments independently of one another.

10. The web transport assembly according to claim 7, wherein the friction-based tensioning device comprises a rotation angle measuring device arranged for measuring a rotation angle of the lever element about the rotation axis of the lever assembly to determine the tension of the web.

11. The web transport assembly according to claim 1, wherein the guiding surface has a curved shape for bending the web along the transport path towards the processing unit.

12. The web transport assembly according to claim 1, wherein the transport device is configured for moving the web intermittently along the processing unit.

13. A printer apparatus comprising the web transport assembly according to claim 1, wherein the processing unit comprises a print head assembly configured for forming an image on the web.
